(19) United States
(12) Patent Application Publication
(10) Pub. No.: US 2024/0020944 A1
(43) Pub. Date: Jan. 18, 2024

(54) SYSTEMS AND METHODS FOR SAMPLING AND AUGMENTING UNBALANCED DATASETS

(71) Applicant: Panasonic Intellectual Property Management Co., Ltd., Osaka (JP)

(72) Inventors: Ramdas KRISHNAKUMAR, Singapore (SG); Ariel BECK, Singapore (SG); Zong Sheng TANG, Singapore (SG); Khai Jun KEK, Singapore (SG); Satyam SATYAM, Singapore (SG); Masahiro ISHII, Kyoto (JP); Yuto KITAGAWA, Osaka (JP)

(21) Appl. No.: 17/867,173

(22) Filed: Jul. 18, 2022

(51) Int. Cl. G06V 10/72; G06V 10/762; G06V 10/764; G06V 10/74; G06V 10/98

(52) U.S. Cl. CPC G06V 10/72; G06V 10/762; G06V 10/764; G06V 10/761; G06V 10/993

(57) ABSTRACT

A method and system for sampling and augmenting a dataset associated with a first class and a second class, respectively, to balance the dataset of images is described. The method includes receiving a required number of reduced set of dataset images associated with the first class, creating a plurality of clusters from a set of images associated with the first class, and selecting a representative image from each cluster to provide a reduced set of images. Further, a median image and a non-defect artifact mask is generated corresponding to the set of images associated with the first class. Additionally, a defect foreground is extracted based on the median image and each defect image of another set of images associated with the second class. Finally, the at least one non-defect artifact is removed from the defect foreground to provide a new synthetic defect image for each defect image for augmentation.

### FIELD OF THE INVENTION

The present invention generally relates to unbalanced datasets, and more particularly relates to systems and methods for sampling and augmenting unbalanced datasets.

### BACKGROUND

Classification problems are quite common in the machine learning world. When data is collected from real world scenarios, it is often highly unbalanced. Imbalanced data refers to those types of datasets where the target class has an uneven distribution of observations, i.e., one class label has a very high number of observations and the other has a very low number of observations. In other words, a particular class may have a huge number of datapoints in comparison to the others.

Further, managing huge datasets provides significant challenges. For example, there may be several difficulties in storing, indexing, and managing large amounts of data that is required for certain systems to function. One area in which such problems arise includes systems that search for and identify a target class of data from large datasets. Storage of the actual data points makes up much of the storage volume in a database.

While there are some methods to train a model on unbalanced dataset (weighting the cost, data augmentation etc,), it is still a challenging issue and can result in a machine learning model with high overall accuracy, but completely useless for the target application.

Accordingly, there is a need for a system and method to balance the unbalanced datasets. Further, there is a need to balance the majority and minority classes of data within unbalanced datasets.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

According to one embodiment of the present disclosure, a method for sampling a set of data points associated with a single class is disclosed. The method includes receiving a required number of reduced set of data points. Further, the method includes determining a neighbour count for the set of data points based on the required number of reduced set of data points and based on a number of the set of data points. Furthermore, the method includes creating a plurality of clusters from the set of data points, each of the plurality of clusters comprising a plurality of similar data points selected based on a similarity threshold, wherein a number of the plurality of similar data points in each of the plurality of clusters is less than or equal to the neighbour count. Additionally, the method includes selecting a representative data point from the plurality of similar data points, for each of the plurality of clusters. Finally, the method includes providing the reduced set of data points based on representative data points, wherein a number of the representative data points corresponds to the received required number of reduced data points.

According to another embodiment of the present disclosure, a method for sampling and augmenting a dataset of images associated with a first class and a second class, respectively, to balance the dataset of images is disclosed. The method includes receiving a required number of reduced set of images associated with the first class. Further, the method includes creating a plurality of clusters from a set of images associated with the first class based on the required number of reduced set of images. Furthermore, the method includes selecting a representative image from a plurality of similar images in the corresponding cluster, for each of the plurality of clusters. Additionally, the method includes providing the reduced set of images based on representative images, wherein a number of the representative images corresponds to the received required number of reduced images. Still further, the method includes generating a median image corresponding to the set of images associated with the first class, wherein the median image represents a background of the set of images. Moreover, the method includes creating a non-defect artifact mask based on a difference of intensity occurring at each pixel between the median image and the set of images associated with the first class. In addition, the method includes extracting a defect foreground based on the median image and each defect image of another set of images associated with the second class, wherein the defect foreground comprises the defect and at least one non-defect artifact. Further, the method includes removing the at least one non-defect artifact from the defect foreground based on the non-defect artifact mask to generate a defect foreground without artifacts for each defect image. Finally, the method includes providing, is for each defect image, a new synthetic defect image based on the median image and the defect foreground without artifacts.

According to yet another embodiment of the present disclosure, a system for sampling of a set of data points associated with a single class is disclosed. The system comprises a memory storing instructions, and a processor configured to execute the instructions to perform operations to: receive a required number of reduced set of data points; determine a neighbour count for the set of data points based on the required number of reduced set of data points and based on a number of the set of data points; create a plurality of clusters from the set of data points, each of the plurality of clusters comprising a plurality of similar data points selected based on a similarity threshold, wherein a number of the plurality of similar data points in each of the plurality of clusters is less than or equal to the neighbour count; for each of the plurality of clusters, select a representative data point from the plurality of similar data points; and provide the reduced set of data points based on representative data points wherein a number of the representative data points corresponds to the received required number of reduced data points.

According to yet another embodiment of the present disclosure, a system for sampling and augmenting a dataset of images associated with a first class and a second class, respectively, to balance the dataset of images is disclosed. The system comprises a memory storing instructions, and a processor configured to execute the instructions to perform operations to: receive a required number of reduced set of images associated with the first class; create a plurality of clusters from a set of images associated with the first class based on the required number of reduced set of images; for each of the plurality of clusters, select a representative image from a plurality of similar images in the corresponding cluster; provide the reduced set of images based on representative images, wherein a number of the representative images corresponds to the received required number of reduced images; generate a median image corresponding to the set of images associated with the first class, wherein the median image represents a background of the set of images; create a non-defect artifact mask based on a difference of intensity occurring for each pixel between the median image and the set of images associated with the first class; extract defect foreground based on the median image and each defect image from another set of images associated with the second class, wherein the defect foreground comprises the defect and at least one non-defect artifact; remove the at least one non-defect artifact from the defect foreground based on the non-defect artifact mask to generate a defect foreground without artifacts for each defect image; and provide, for each defect image, a new synthetic defect image based on the median image and the defect foreground without artifacts.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a process flow for sampling a set of data points associated with a single class, according to an embodiment of the present invention.

FIG. 2 illustrates a pictorial representation of sampling a set of data points having a plurality of statistical features associated with a single class, according to an embodiment of the present invention;

FIGS. 3A-3B illustrate an exemplary process flow comprising a method for sampling a set of data points associated with a single class, according to an embodiment of the present invention;

FIGS. 4A-4C illustrate an exemplary process flow comprising a method for sampling and augmenting a dataset of images associated with a first class and a second class, respectively, to balance the dataset of images, according to an embodiment of the present invention;

FIG. 5 illustrates an exemplary process flow comprising a method for augmenting a dataset of images associated with a second class to balance the dataset of images, according to an embodiment of the present invention:

FIG. 6 illustrates an exemplary process flow comprising a workflow for augmenting a dataset of images associated with a second class to balance the dataset of images, according to an embodiment of the present invention:

FIG. 7 illustrates another exemplary process flow comprising a workflow with iterative version based on false positives for augmenting a dataset of images associated with a second class to balance the dataset of images, according to an embodiment of the present invention:

FIG. 8 illustrates a schematic block diagram of a system for sampling and augmenting a dataset of images associated with a first class and a second class, respectively, to balance the dataset of images, according to an embodiment of the present invention:

FIGS. 9A and 9B illustrate an exemplary use case depicting a method for sampling a set of data points associated with a single class, according to an embodiment of the present invention;

FIG. 10 illustrates a process flow for selection of representative images from a cluster during sampling of a set of data points associated with a single class, according to an embodiment of the present invention;

FIGS. 11A-11E illustrate various methods of selecting a seed image from each of the plurality of clusters during sampling of a set of data points associated with a single class, according to various embodiments of the present invention:

FIG. 12 illustrates some exemplary scenarios of neighbor count and corresponding clusters during sampling of a set of data points associated with a single class, according to an embodiment of the present invention:

FIG. 13 illustrates an exemplary comparison of variation of the compression ratio with respect to similarity threshold and the cluster sizes during sampling of a set of data points associated with a single class, according to an embodiment of the present invention:

FIGS. 14A-14E illustrate a few exemplary depictions of variation of the compression ratio with respect to similarity threshold and the cluster sizes during sampling of a set of data points associated with a single class, according to an embodiment of the present invention;

FIGS. 15A-15F illustrate yet another exemplary depiction of variation of the compression ratio with respect to similarity threshold and the cluster sizes during sampling of a set of data points associated with a single class, according to an embodiment of the present invention; and

FIG. 16 illustrates an exemplary use case scenario depicting a series of pie charts indicating balancing in datasets using sampling and augmentation processes, according to various embodiments of the present invention.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the is invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The present invention is directed towards a method and system for addressing the issue of class imbalance in a dataset. Specifically, the embodiments are directed towards sampling/reducing the data points in the majority class of the dataset. Further, some embodiments are directed towards augmentation process of the minority class of data points within the dataset, where the class imbalance at the outset was severe.

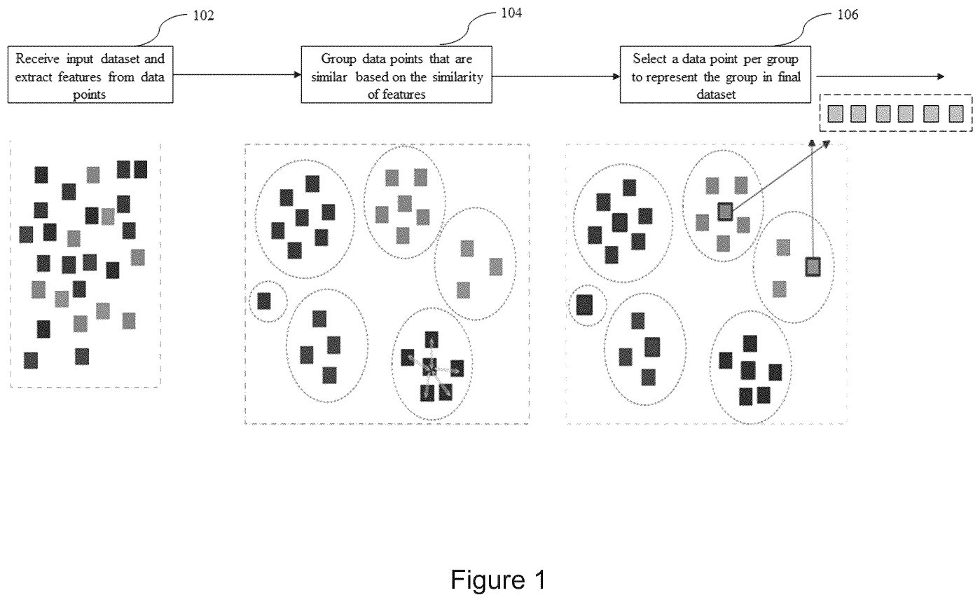

FIG. 1 illustrates a process flow for sampling a set of data points associated with a single class, according to an embodiment of the present invention. As illustrated, at step 102 of the process flow, an input dataset is received which comprises a plurality of data points. In an embodiment, the input dataset comprises unbalanced data points associated one or more classes, such as a majority class and a minority class. The majority class may correspond to a set of data points which are greater in number than the data points associated with minority class. For instance, there may be 1 million data points associated with bank transactions. If someone tries to identify fraudulent transactions of these 1 million transactions, these might only be around 5000-10000. Accordingly, the fraudulent or target transactions may be termed as minority class, while the other remaining transactions may be associated with the majority class. As discussed throughout this disclosure, the sampling of the set of data points is performed on the data points associated with the majority class of data points from the received unbalanced data set.

Further, at step 102, one or more statistical features are extracted from the data points of the majority class. In an exemplary embodiment where each input data corresponds to an image, some exemplary statistical features of each of the data points may include, but not limited to, average, median, standard, minimum, maximum, skew, and kurtosis of pixels of the image. Subsequently, these extracted statistical features are clustered to identify similar data points.

At step 104 of the process flow, the data points are grouped or clustered which are similar to each other based on similarity of extracted statistical features. In one embodiment, the similarity of extracted statistical features may be identified based on a predefined similarity threshold. Accordingly, a plurality of clusters is created from the set of data points of the majority class. Each of the clusters comprises a plurality of similar data points selected based on the similarity threshold between the data points. All data points which do not form a part of any cluster remain in the initial set of data points. In some embodiments, a cluster formation may be initiated based on a seed data point or image selected from the initial set of received data points/images associated with majority class. A seed data point may be selected randomly or based on one or more embodiments, as discussed throughout the disclosure.

At step 106, a representative data point is selected from each cluster or group, wherein each representative data points represents the corresponding cluster. Subsequently, a group of representative data points is output as a reduced set of data points which represents the majority class. The above process may be repeated till a required reduction is achieved. However, in each subsequent iteration, the set of data points, which formed a part of any cluster(s)/group(s) during any previous iteration(s), are not taken into consideration. Only the remaining set of data points are taken into consideration which were never a part of any cluster/group. In an embodiment, a similarity check may be performed after each iteration to ensure that enough similarity is left in the remaining set of data points for another iteration of reduction.

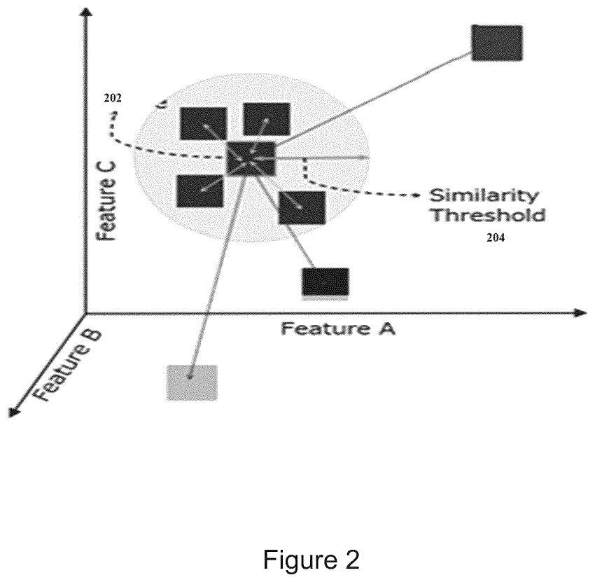

FIG. 2 illustrates a pictorial representation of sampling a set of data points having a plurality of statistical features associated with a single class, according to an embodiment of the present invention. As depicted, FIG. 2 illustrates creating a group/cluster of similar data points and selecting a representative data point, as discussed previously in steps 104 and 106 of FIG. 1. The plurality of similar data points for creating a cluster are identified based on a similarity threshold 204 among the one or more statistical features (e.g., features A, B. and C) of the set of data points. In an exemplary embodiment, a seed data point 202 may initially be identified as a starting point of a cluster/group formation. Other data points for inclusion in the cluster may be identified based on the similarity threshold 204 distance between such each of the other data points and the seed data point 202.

According to various embodiments of the present invention, the similarity threshold is a control of the radius of acceptable region around the seed data point 202 of a cluster. The similarity threshold 204 may be configurable based on a required reduction of data set, as per a predefined mapping table. This is explained in conjunction with various Figures throughout this disclosure. Thus, the larger the region of similarity threshold, there would be more data points per cluster and thus, lesser number in final output of representative data points.

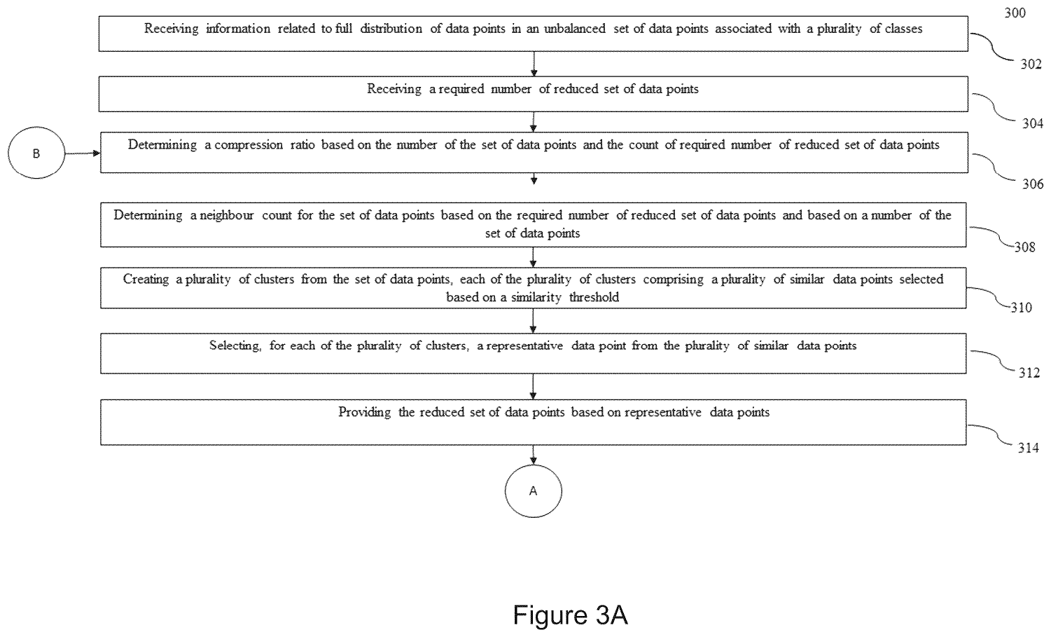

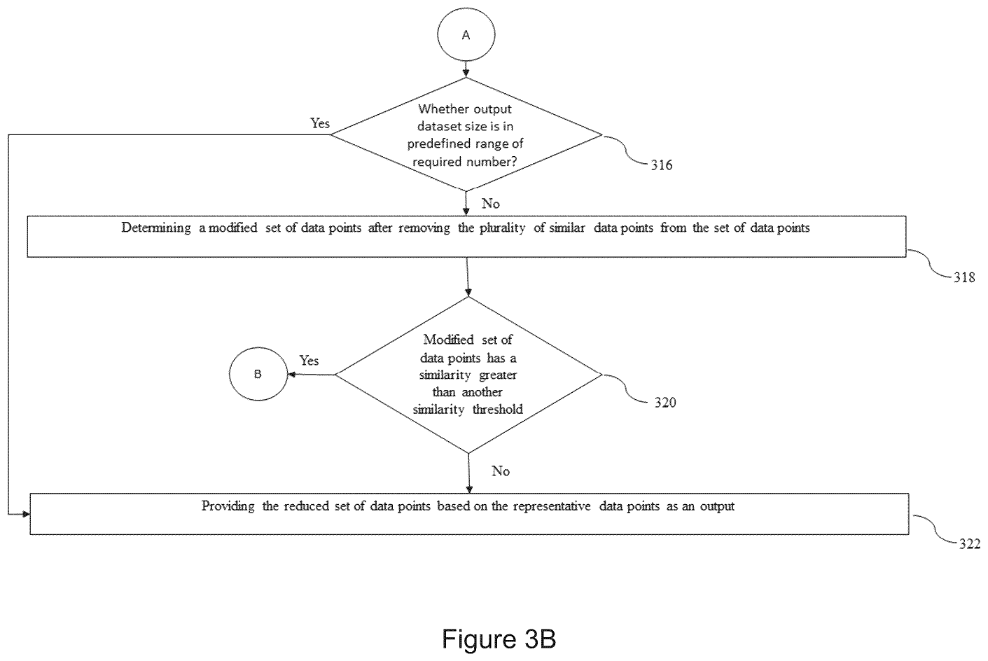

FIGS. 3A-3B illustrate an exemplary process flow comprising a method 300 for sampling a set of data points associated with a single class, according to an embodiment of the present invention. For the sake of brevity, details of the present disclosure that are explained in detail in the description of FIG. 1 and FIG. 2 are not explained in detail in the description of FIGS. 3A and 3B.

At step 302, the method 300 comprises receiving information related to full distribution of data points in an unbalanced set of data points associated with a plurality of classes. The unbalanced set of data points may include data points associated with a majority class and a minority class. The further steps of the present embodiment are associated with sampling of the set of data points associated with the majority class from the unbalanced set of data points. Further, in exemplary embodiment, the data points may correspond to, but not limited to, images or transaction data points.

At step 304, the method 300 comprises receiving a required number of reduced set of data points associated with the majority class of data points. In an exemplary embodiment the required number of reduced set of data points may be, but not limited to, 2%, 5% or 10% of a total number of data points within the majority class of the unbalanced data. In one embodiment, the required number of reduced set of data points may be automatically determined based on the full distribution of data points in the unbalanced set of data points. For example, the system implementing the present invention may be configured to automatically set the required number of reduced set of data points based on a predefined information or formula stored in a database. In some other embodiments, the required number of reduced data points associated with the majority class of data points may be received as an input from the user.

At step 306, the method 300 comprises determining a compression ratio based on the number of the set of data points and the count of required number of reduced set of data points. In an exemplary embodiment, the compression ratio may be a ratio of count of required number of reduced data points and the total number of the set of data points associated with the majority class.

At step 308, the method 300 comprises determining a neighbour count for the set of data points based on the required number of reduced set of data points and based on a number of the set of data points associated with the majority class. Further, a similarity threshold may also be selected based on the required number of reduced set of data points and based on a number of the set of data points associated with the majority class. In an embodiment, the similarity threshold and the neighbour count may be determined based on the compression ratio.

In an exemplary embodiment, the neighbour count may be determined based on a predefined ruleset stored within a database associated with the system executing the present invention, as discussed later throughout the disclosure. An exemplary ruleset for determination of the neighbour count based on the compression ratio and a similarity threshold is provided below in Table 1:

TABLE 1

| Compression | Similarity | Neighbor |
|---|---|---|
| Ratio | Threshold | count |
| CR > 0.25 | 80 | 5 |
| 0.25 > CR > 0.15 | 60 | 7 |
| 0.15 > CR > 0.10 | 50 | 10 |
| 0.10 > CR > 0.05 | 40 | 20 |
| 0.05 > CR | 40 | 30 |

As depicted, a specific range of the compression ratio leads to determination or selection of a specific similarity threshold and a neighbour count.

At step 310, the method 300 comprises creating a plurality of clusters from the set of data points, each of the plurality of clusters comprising a plurality of similar data points selected based on a similarity threshold. As discussed previously, in an embodiment, the creation of each cluster may be initiated with selection of a seed data point, and other data points within each cluster may be identified based on the similarity threshold and the neighbour count.

Further, in an embodiment, the cluster may be created by extracting at least one statistical feature for each data point of the set of data points. Subsequently, a statistical distance between the at least one statistical feature of each of two data points from the set of data points may be determined, wherein the two data points are identified within a particular threshold distance. Finally, the plurality of similar data points from the set of data points associated with majority class may be selected based on the determined statistical distance among the plurality of similar data points, wherein a count of the plurality of similar data points is less than or equal to the neighbour count.

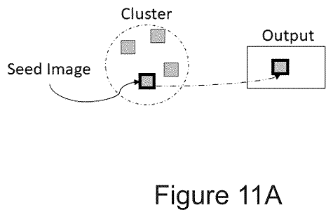

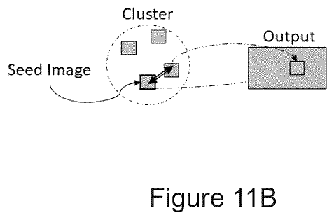

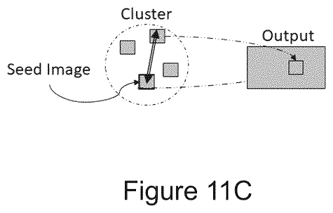

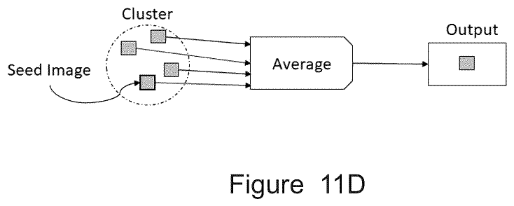

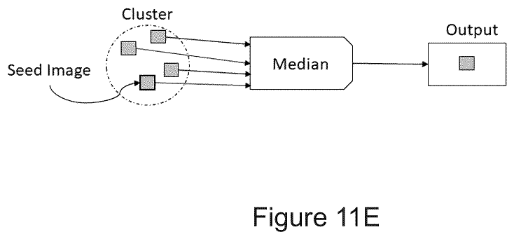

At step 312, the method 30) comprises selecting, for each of the plurality of clusters, a representative data point from the plurality of similar data points. In an embodiment, the representative data point may correspond to the seed data point. In some embodiments, the representative data point may correspond to multiple data points. The various embodiments for selection of the representative data points are explained in conjunction with FIGS. 11A-11E.

At step 314, the method 300 comprises providing the reduced set of data points based on representative data points. Once a representative data point is selected for each of the plurality of clusters, an output comprising such representative data points is provided which corresponds to the reduced set of data points.

At step 316, the method 300 comprises determining whether output dataset size is within predefined range of required number of reduced set of data points. The predefined range may be set within the system implementing the present invention, as discussed later throughout this disclosure. Based on a determination that the output dataset size is within the predefined range of required number of reduced data points, the method 300 proceeds to step 322 where the reduced set of data points comprising the plurality of representative data points is provided as an output.

At step 318, the method 300 comprises determining a modified set of data points after removing the plurality of similar data points from the set of data points, based on a determination that the output dataset size is not within the predefined range of required number of reduced data points.

At step 320, the method 300 comprises determining whether modified set of data points has a similarity greater than another similarity threshold. The another similarity threshold is predefined and stored within the system implementing the present invention. The modified set of data points correspond to remaining data points of the initially received set of data points associated with majority class after removing the plurality of similar data points that were included within any of the clusters. In response to a determination that the modified set of data pints does have a similarity greater than the another similarity threshold, the method 300 proceeds to step 306 where a new compression ratio may be determined based on required set of reduced data points in the next iteration/round and the remaining/modified set of data points after removing the plurality of similar data points that were a part of any cluster in the previous rounds.

At step 322, the method 300 comprises providing the reduced set of data points based on the representative data points as an output, based on a determination that the modified set of data pints does not have a similarity greater than the another similarity threshold.

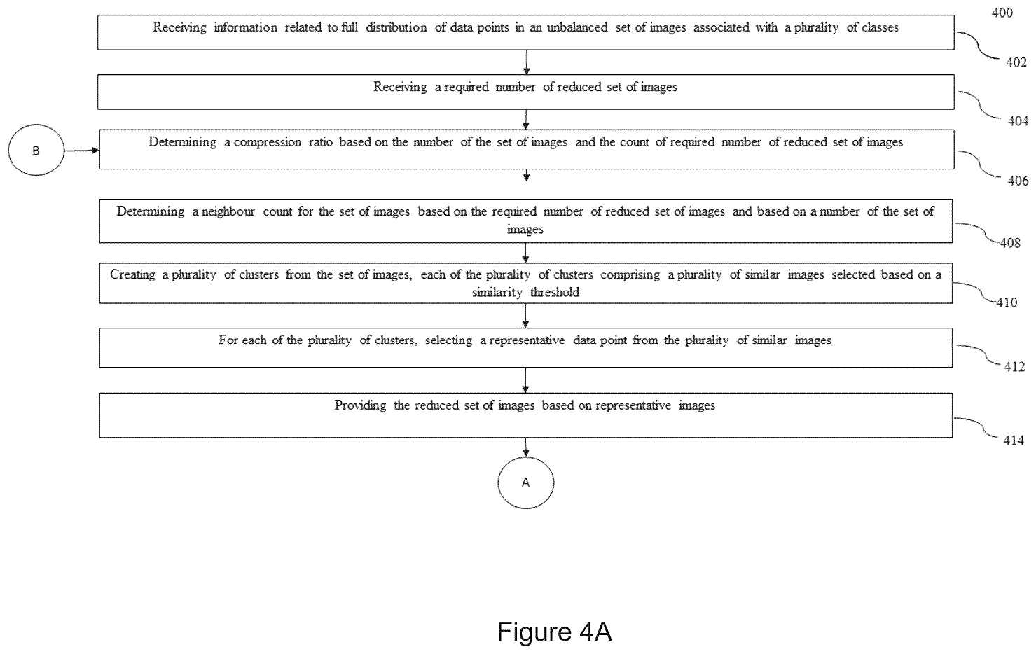

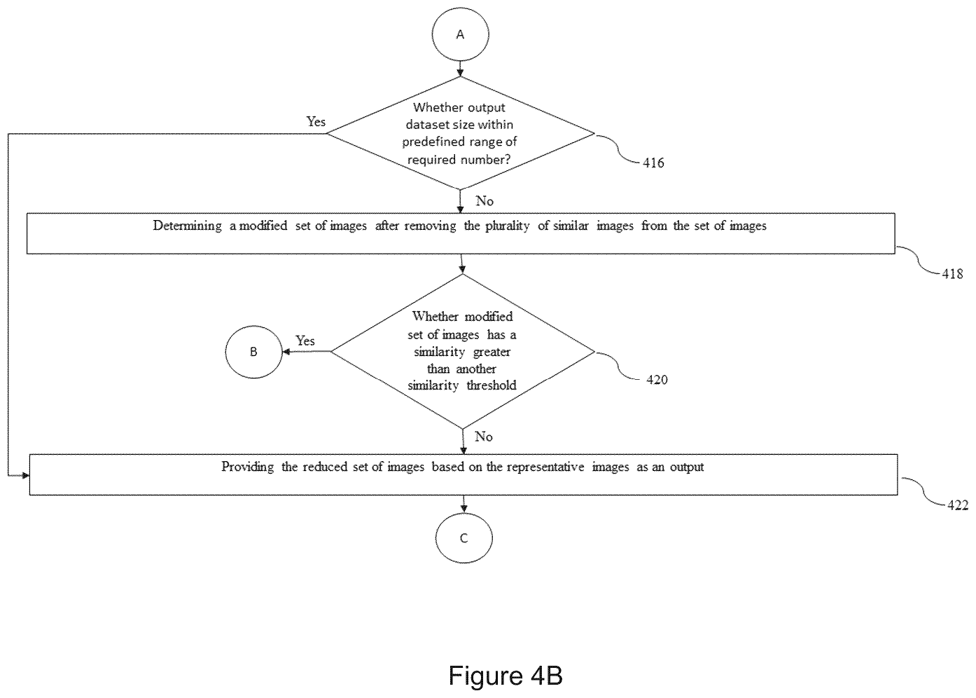

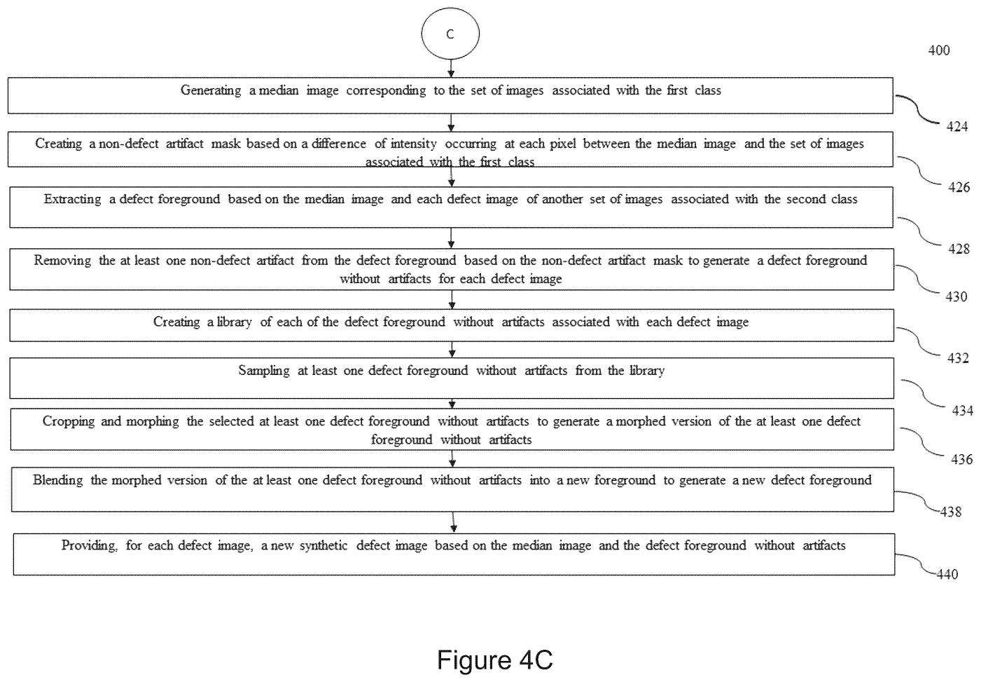

FIGS. 4A-4C illustrate an exemplary process flow comprising a method 400 for sampling and augmenting a dataset of images associated with a first class (i.e., majority class) and a second class (i.e., minority class), respectively, to balance the dataset of images, according to an embodiment of the present invention. While steps 402 to 422 correspond to sampling of images associated with majority class of unbalanced data set of images, steps 424 to 440 correspond to image synthesis/augmentation for dataset balancing of defective class of images associated with the minority class of unbalanced dataset of images. Steps 402 to 422 correspond to step 302 to 322 of FIGS. 3A-3B, except that the data points are images. Accordingly, for the sake of brevity, the steps 402-422 are not discussed here in detail.

At step 424, the method 400 comprises generating a median image corresponding to the set of images associated with the first class. In one embodiment, generating the median image comprises calculating, for each pixel of the median image, a median intensity occurring at the corresponding pixel across the set of images associated with the majority class of images. Subsequently, the median image is generated based on the calculated median intensity for each pixel of the set of images associated with the majority class of images.

At step 426, the method 400 comprises creating a non-defect artifact mask based on a difference of intensity occurring at each pixel between the median image and the set of images associated with the first class. The non-defect artifact mask is a visible feature in the foreground that are not defects. These may arise out of edges and texture differences in the image.

At step 428, the method 400 comprises extracting a defect foreground based on the median image and each defect image of another set of images associated with the second class. The defect foreground is a visible feature identifying a defect present in the foreground.

At step 430, the method 400 comprises removing the at least one non-defect artifact from the defect foreground based on the non-defect artifact mask to generate a defect foreground without artifacts for each defect image.

At step 432, the method 400 comprises creating a library of each of the defect foreground without artifacts associated with each defect image.

At step 434, the method 400 comprises sampling at least one defect foreground without artifacts from the library.

At step 436, the method 400 comprises cropping and morphing the selected at least one defect foreground without artifacts to generate a morphed version of the at least one defect foreground without artifacts.

At step 438, the method 400 comprises blending the morphed version of the at least one defect foreground without artifacts into a new foreground to generate a new defect foreground.

At step 440, the method 400 comprises providing, for each defect image, a new synthetic defect image based on the median image and the defect foreground without artifacts. The synthetic defect image is an image that simulates an image of a defective item.

Thus, in steps 424-440, the present invention attempts to decompose a given image into a foreground and a background. Typically, background captures the features that are present in a normal (OK) item. The foreground captures features that are edge or texture artifacts (i.e., non-defect artifacts) and defects features as well. Once, the foreground background decomposition is done, the defects from the foreground can be extracted to compile a defect library. The defect library once composed is used to create synthetic images of defective items.

FIG. 5 illustrates an exemplary process flow comprising a method 500 for augmenting a dataset of images associated with a second class to balance the dataset of images, according to an embodiment of the present invention. The method 500 corresponds to a technique of defect augmentation, i.e., image synthesis for dataset balancing of defective class associated with the minority class of images. FIG. 5 illustrates steps 424430 and 436-440 along with a pictorial representation of images and artifacts at each step. For the sake of brevity, the description associated with the said steps is not repeated here in FIG. 5 again.

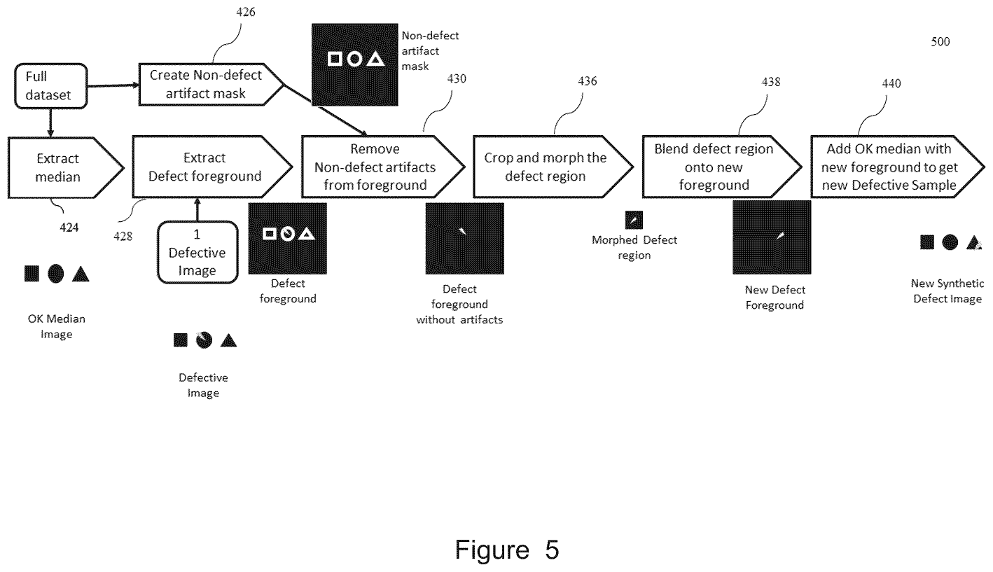

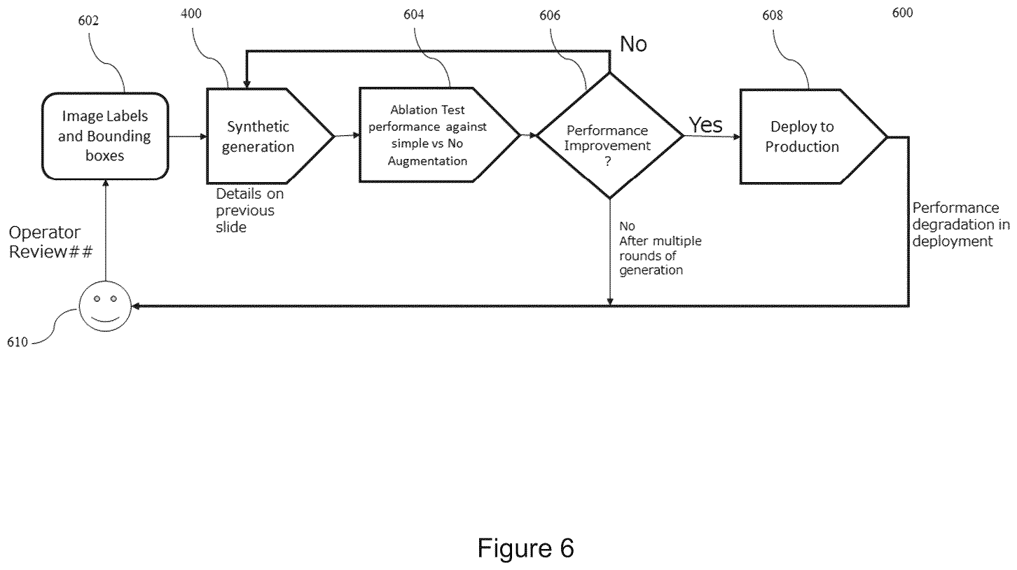

FIG. 6 illustrates an exemplary workflow 600 implementing the method 400 for augmenting a dataset of images associated with a second class to balance the dataset of images, according to an embodiment of the present invention.

At step 602, the workflow 600 may include obtaining image labels and bounding boxes associated with the set of images associated with the minority class.

Subsequently, the synthetic generation method 400 is applied for augmenting the images in minority class.

Further, at steps 604 and 606, the workflow 600 may include determining whether the new synthetic defect image indicates performance improvement by performing an ablation test performance on the new synthetic defect image. If there is a performance improvement, then the workflow proceeds to step 608 which includes outputting the new synthetic defect image as a final output. The set of images are then deployed for production at step 608. Alternatively, the workflow 600 may proceed to deploy synthetic generation 400 technique including repeating the steps of generating the median image, creating, extracting defect foreground, removing, and providing the new synthetic defect image based on a determination that the new synthetic defect image does not indicate performance improvement.

Further, a continuous check is performed for performance of the synthetic generated images. Upon detecting any performance degradation during deployment of the synthetic generated images, the workflow 600 may proceed for manual intervention through a message on a user interface of the system/device implementing the present invention. The manual intervention is required at the input level only. The manual operator need not handle/inspect the synthetic generated images. Additionally, the manual intervention may also be required in case there is no performance improvement detected even after multiple iterations/rounds of synthetic image generation.

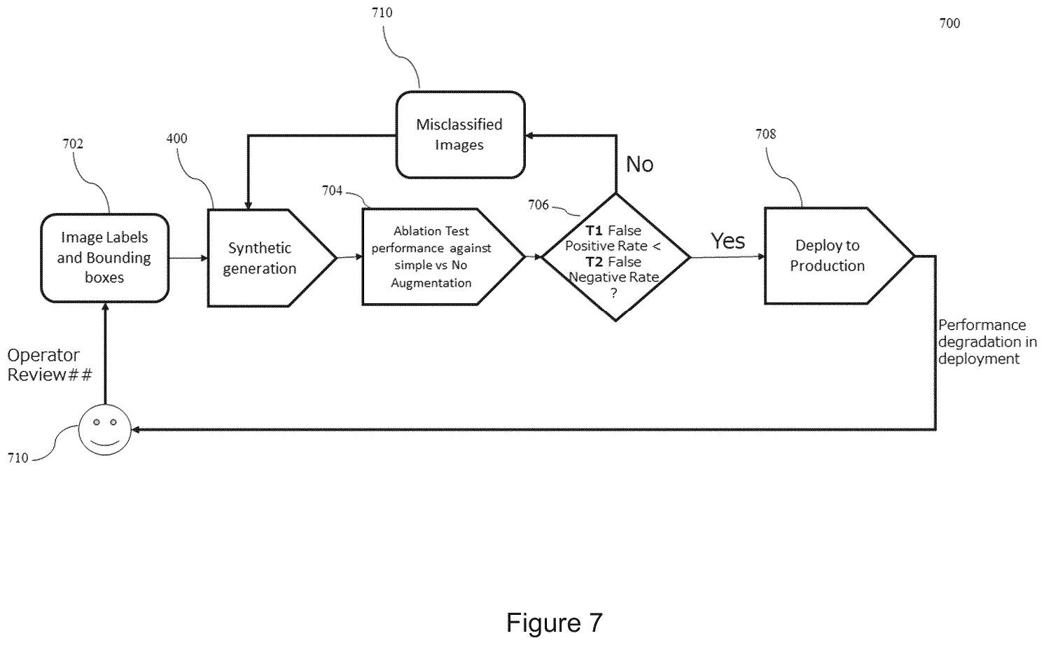

FIG. 7 illustrates another exemplary process flow 700 comprising a workflow with iterative version based on false positives for augmenting a dataset of images associated with a second class to balance the dataset of images, according to an embodiment of the present invention. It is to be noted that steps 702, 704, 708, and 710 correspond to steps 602, 604, 608, and 610 of FIG. 6. Hence, for the sake of brevity, the steps are not discussed here in detail.

At step 706, the workflow comprises comparing T1 false positive rate with T2 false negative rate and proceeding to step 708 upon detecting that the false positive rate is lesser than false negative rate. Additionally, upon detecting that T1 false positive rate is greater than T2 false negative rate, the workflow proceeds to infer that the synthetic generated images comprise misclassified images, and there is a need for further iteration of implementing method 400. Steps 706 and 708 describe a recursive method where the defect library is created using only those images of the minority class which get misclassified as majority class by the classifier. Once the defect library is created, all the remaining steps are similar to FIG. 6. In the previous FIG. 6, the augmentation method was related to creating synthetic samples of the minority class (i.e., defect containing) class. Thus, the augmentation method of FIG. 6 involved creation of a defect library using all images in the minority class. In contrast, the embodiment of FIG. 7 is directed towards creating the defect library using only those images of the is minority class which get misclassified as majority class by the classifier.

While the above discussed steps in FIGS. 3-7 are shown and described in a particular sequence, the steps may occur in variations to the sequence in accordance with various embodiments.

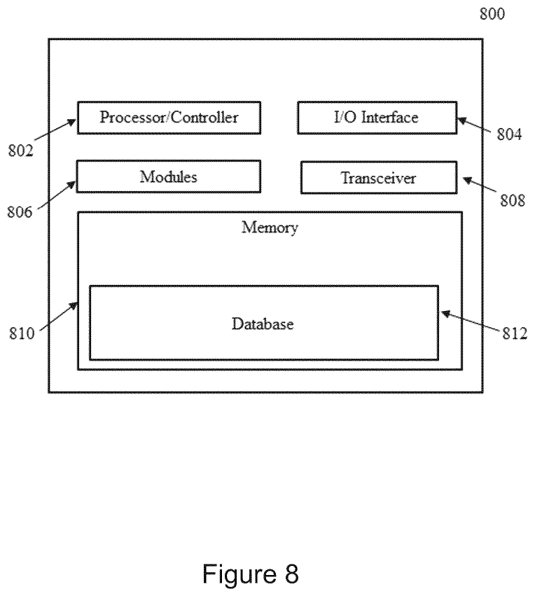

FIG. 8 illustrates a schematic block diagram of a system 800 for sampling and augmenting a dataset of images associated with a first class and a second class, respectively, to balance the dataset of images, according to an embodiment of the present invention. In one embodiment, the system 800 may be used to implement the method 400 for sampling and augmenting a dataset of images, as discussed previously in conjunction with FIG. 4. Further, the system 800 may be used for implementing the method 300 for sampling of a set of data points associated with a majority class, as discussed previously in conjunction with FIG. 3.

In one embodiment, the system 800 may be included within a mobile device or a server. Examples of mobile device may include, but not limited to, a laptop, smart phone, a tablet, or any electronic device having a capability to access internet and to install a software application(s). The system 800 may further include a processor/controller 802, an I/O interface 804, modules 806, transceiver 808, and a memory 810.

In some embodiments, the memory 810 may be communicatively coupled to the at least one processor/controller 802. The memory 810 may be configured to store data, instructions executable by the at least one processor/controller 802. In some embodiments, the modules 806 may be included within the memory 810. The memory 810 may further include a database 812 to store data. The one or more modules 806 may include a set of instructions that may be executed to cause the system 800 to perform any one or more of the methods disclosed herein. The one or more modules 806 may be configured to perform the steps of the present disclosure defined in FIGS. 3-7 using the data stored in the database 812, to perform sampling and augmentation of a set of data points/images, as discussed throughout this disclosure. In an embodiment, each of the one or more modules 806 may be a hardware unit which may be outside the memory 810. The transceiver 808 may be capable of receiving and transmitting signals to and from system 800. The I/O interface 804 may include a display interface configured to receive user inputs and display output of the system 800 for the user(s). Specifically, the I/O interface 804 may provide a display function and one or more physical buttons on the system 800 to input/output various functions, as discussed herein. Other forms of input/output such as by voice, gesture, signals, etc. are well within the scope of the present invention. For the sake of brevity, the architecture and standard operations of memory 810, database 812, processor/controller 802, transceiver 808, and I/O interface 804 are not discussed in detail. In one embodiment, the database 812 may be configured to store the information as required by the one or more modules 806 and processor/controller 802 to perform one or more functions to perform the sampling and augmentation of data points.

In one embodiment, the memory 810 may communicate via a bus within the system 800. The memory 810 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 810 may include a cache or random-access memory for the processor/controller 802. In alternative examples, the memory 810 is separate from the processor/controller 802, such as a cache memory of a processor, the system memory, or other memory. The memory 810 may be an external storage device or database for storing data. The memory 810 may be operable to store instructions executable by the processor/controller 802. The functions, acts or tasks illustrated in the figures or described may be performed by the programmed processor/controller 802 for executing the instructions stored in the memory 810. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

Further, the present invention contemplates a computer-readable medium that includes instructions or receives and executes instructions responsive to a propagated signal, so that a device connected to a network may communicate voice, video, audio, images, or any other data over a network. Further, the instructions may be transmitted or received over the network via a communication port or interface or using a bus (not shown). The communication port or interface may be a part of the processor/controller 802 or maybe a separate component. The communication port may be created in software or maybe a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the system 800 may be physical or may be established wirelessly. The network may alternatively be directly connected to the bus.

In one embodiment, the processor/controller 802 may include at least one data processor for executing processes in Virtual Storage Area Network. The processor/controller 802 may include specialized processing units such as, integrated system (bus) controllers, memory management control units, floating point units, graphics processing units, digital signal processing units, etc. In one embodiment, the processor/controller 802 may include a central processing unit (CPU), a graphics processing unit (GPU), or both. The processor/controller 802 may be one or more general processors, digital signal processors, application-specific integrated circuits, field-programmable gate arrays, servers, networks, digital circuits, analog circuits, combinations thereof, or other now known or later developed devices for analyzing and processing data. The processor/controller 802 may implement a software program, such as code generated manually (i.e., programmed).

The processor/controller 802 may be disposed in communication with one or more input/output (I/O) devices via the I/O interface 804. The I/O interface 804 may employ communication code-division multiple access (CDMA), high-speed packet access (HSPA+), global system for mobile communications (GSM), long-term evolution (LTE), WiMax, or the like, etc.

The processor/controller 802 may be disposed in communication with a communication network via a network interface. The network interface may be the I/O interface 804. The network interface may connect to a communication network. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

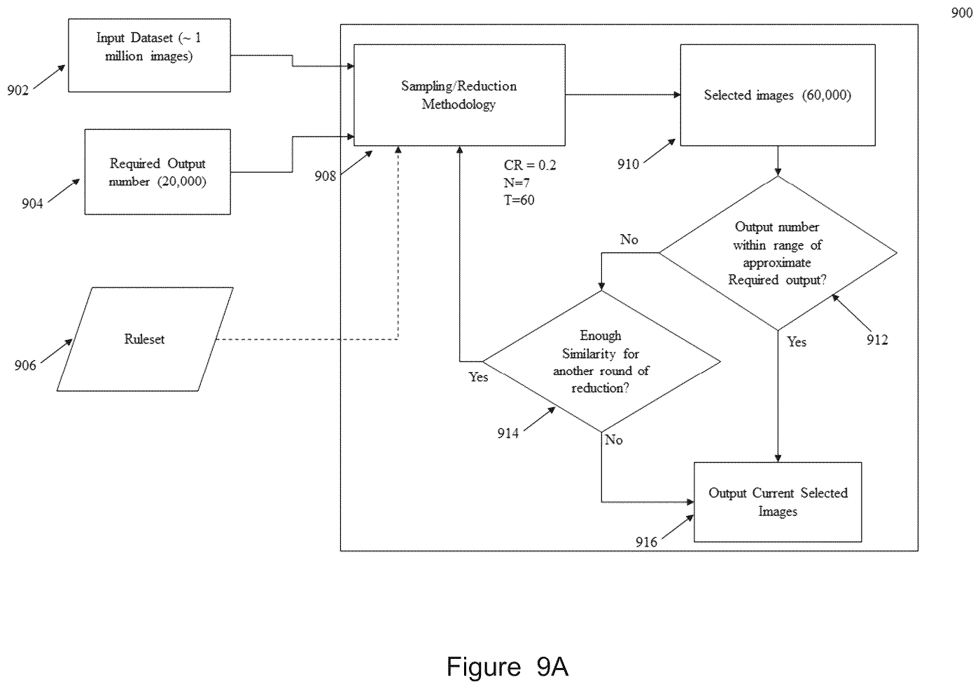

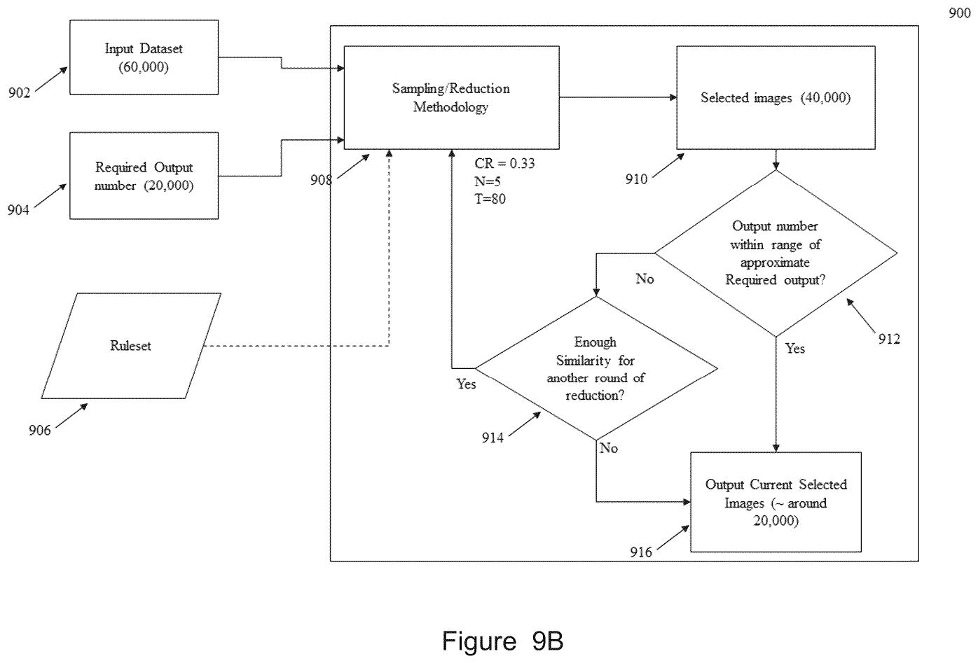

FIGS. 9A and 9B illustrate an exemplary use case depicting a method 900 for sampling a set of data points associated with a single class, according to an embodiment of the present invention. Specifically, FIGS. 9A and 9B correspond to two iterations of sampling the set of data points.

As depicted in FIG. 9A, the input dataset at step 902 associated with the majority class may include 1 million images, while the required output data points may include 20,000 images at step 904. Based on the ruleset 906 stored within a database of the system (e.g., system 800) implementing the present invention, a compression ration may be determined, which shall be determined in the manner as discussed above. In this case, the compression ratio shall be 0.02. Further, based on the ruleset 906 (e.g., Table 1, as discussed above), a corresponding neighbour count of 30 and a similarity threshold of 40 may be obtained. The sampling/reduction methodology may be implemented at step 908, similar to steps of the method 300 to provide a set of representative data points.

Subsequently, the data points at step 910 may include 60,000 representative images. Further, at step 912, it may be determined whether the output number of images (i.e., 60,000) is within a predefined range of required number of reduced images. For example, if the number of output data points is within an error margin of +/−10%. For example, for a required reduction set of 1000, if the output images are between 900 to 1100, the determination would be that the output number of images are within the predefined range of required number of reduced images.

Since, the output number is much greater than the required number, the method 900 proceeds to step 914. At step 914, it may be determined whether there is enough similarity in the remaining images for another round of reduction.

This step serves as a safety check to prevent data loss as a result of clustering dissimilar images. As an exemplary scenario, if >40% of the images are still quite similar (within 10% of max similarity score). For instance, if 1500 images remain, and 10% of remaining similarity distribution is 0.98, and if number of images with similarity at least 0.98 is >600, then the next iteration would be performed. Similarity distribution is the collection of all similarity scores of pair wise comparison of images within the dataset. Thus, 60th percentile of all similarity values within the comparison matrix should be greater than 90% of Max (all similarity values within the comparison matrix).

In case there is not enough similarity in the remaining images, the method 900 proceeds to step 916 to output currently selected representative images. In case there is enough similarity in the remaining images, the method proceeds to second iteration, as illustrated in FIG. 9B.

As depicted, in FIG. 9B, a new compression ratio may be determined based on the modified input data set of 60,000 images (i.e., the output representative images of first iteration) and the required set of images (i.e., 20,000). Subsequently, a new neighbour count and similarity threshold may be selected based on Table 1 and the reduction methodology may be repeated till the final output representative images are within a predefined range of required number reduced set of images, or till there is not enough similarity for another round of reduction.

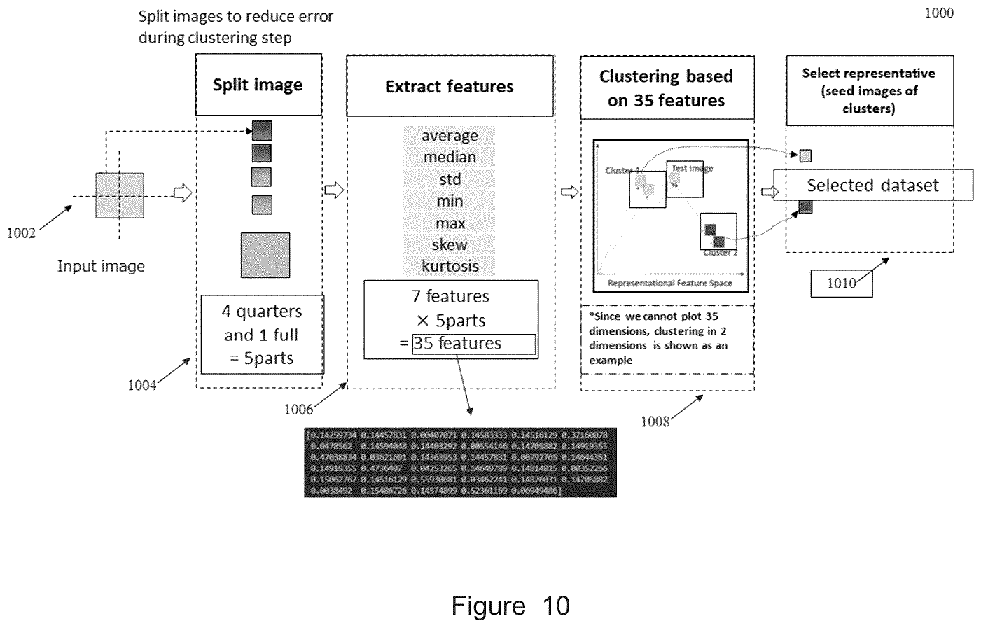

FIG. 10 illustrates a process flow 1000 for selection of representative images from a cluster during sampling of a set of data points associated with a single class, according to an embodiment of the present invention. The method may correspond to seed/representative data point 202 of FIG. 2 and steps 310 and 312 of FIG. 3. As depicted, an input image 1002 may be provided for processing, which may be split into 4 quarters and 1 full part at 1004, in accordance with the exemplary embodiment. Further, one or more statistical features may be extracted at 1006. In an exemplary embodiment where each input data corresponds to an image, some exemplary statistical features of each of the data points may include, but not limited to, average, median, standard, minimum, maximum, skew, and kurtosis of pixels of the image. Since the input image 1002 is split into 5 parts, the total features would be 35. Subsequently, a clustering based on these 35 features may be implemented at 1008. Finally, at 1010, a representative image may be selected for each cluster. The various methodologies of selecting a representative image are discussed in conjunction with FIGS. 11A-11E.

FIGS. 11A-11E illustrate various methods of selecting a seed image from each of the plurality of clusters during sampling of a set of data points associated with a single class, according to various embodiments of the present invention.

FIG. 11A illustrates a preferred embodiment of the present invention comprising a method of selecting the seed image (or data point) which was initially used to form the cluster, to represent the cluster as a representative image. This is the easiest and most robust form of selection of the representative image. Further, this method has no effect due to an impure cluster formation, since the initial image of the cluster is finally outputted. In other words, in case of any false selection of data points or images while cluster formation, the final output remains unaltered and hence, does not have an effect of inaccuracies in cluster formation. Further, in this methodology, the reduction of sample data points is aggressive.

FIG. 11B illustrates a methodology of selecting the seed image and its closest neighbour as the output representative image from the cluster. Accordingly, in this embodiment, the seed image which was used to initially form the cluster and its closest image are selected to represent the cluster. The closest image is selected based on, for example, but not limited to, cosine similarity score. This methodology softens the rate of compression and maintains more similar samples in the output dataset. This methodology can be extended to select the top “x” number of closest neighbours. This methodology has a milder form of reduction compared to the methodology of FIG. 11A.

FIG. 11C illustrates a methodology of selecting the seed image and its farthest neighbour as the output representative image from the cluster. Accordingly, in this embodiment, the seed image which was used to initially form the cluster and its farthest image are selected to represent the cluster. This methodology increases variance in the output dataset and reduces information loss. This methodology can be extended to select the top “x” number of farthest neighbours. This methodology has a milder form of reduction compared to the methodology of FIG. 11A.

FIG. 11D illustrates a methodology of creating an averaged or mean image as the output representative image from the cluster. Specifically, the pixel values in the cluster are averaged to create a mean image to represent the cluster. This methodology is useful if there is a need to maintain information consistent throughout all data points/images in the cluster. However, this methodology is prone to error if clusters are impure.

FIG. 11E illustrates a methodology of creating a median image as the output representative image from the cluster. Specifically, a median of the pixel values in the cluster is used to create a median image to represent the cluster. This methodology is useful if there is a need to remove small outlier points within the image. (i.e., reduce noise). However, this methodology is prone to error if clusters are impure.

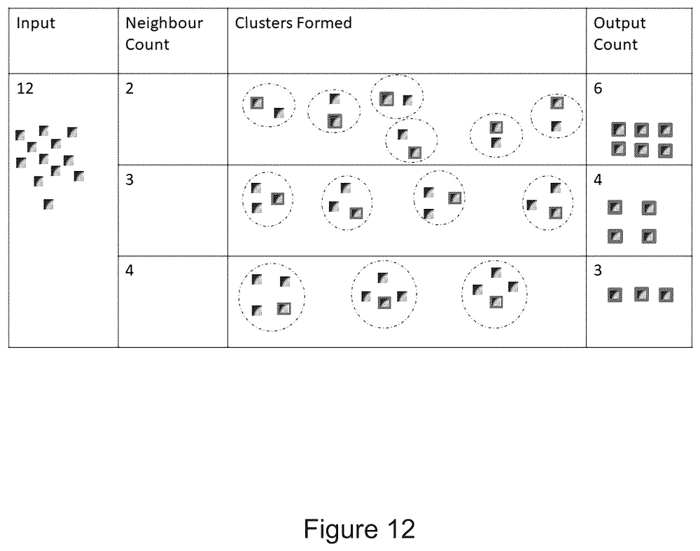

FIG. 12 illustrates some exemplary scenarios of neighbor count and corresponding clusters during sampling of a set of data points associated with a single class, according to an embodiment of the present invention. As explained previously, the neighborhood count is a count of maximum number of data points within a cluster. As depicted in the exemplary scenario of FIG. 12, if the input images are 12, a different number of neighbour count may be implemented for multiple scenarios. In a first exemplary scenario, if a neighbour count of 2 is taken for 12 input set of data points, then six clusters would be formed and hence, six representative data points may be provided as an output.

Similarly, in case of neighbour count being kept as 3, the clusters would be 4 and hence, 4 representative data points may be provided as an output. In another example, in case of neighbour count being kept as 4, the clusters would be 3 and hence, 3 representative data points may be provided as an output. Thus, the larger the neighbour count, more data points will be included per cluster, and lesser number in final output.

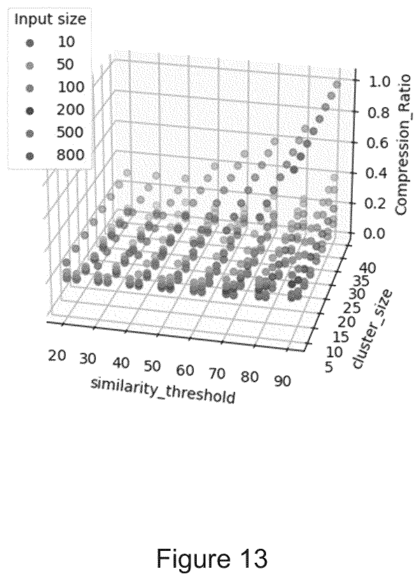

FIG. 13 illustrates an exemplary comparison of variation of the compression ratio with respect to similarity threshold and the cluster sizes during sampling of a set of data points associated with a single class, according to an embodiment of the present invention. As depicted, the FIG. 13 provides the variation of compression ratio for input size of data points as 10, 50, 100, 200, 500, and 800, in cluster sizes and similarity thresholds. As explained previously, the compression ratio may be determined as.

Compression ratio (CR)=size of output dataset/size of input dataset

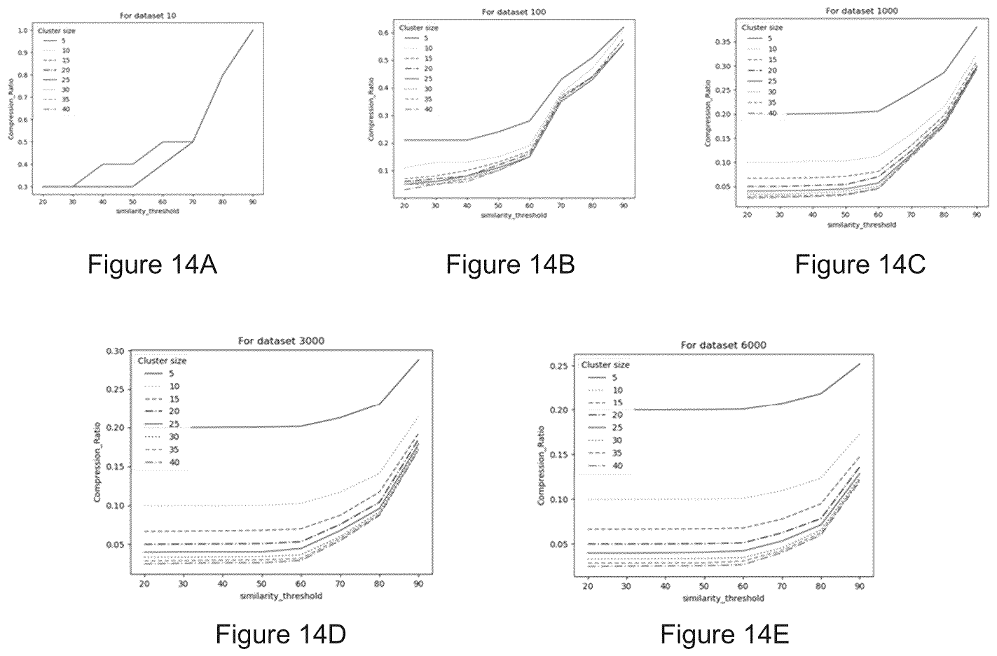

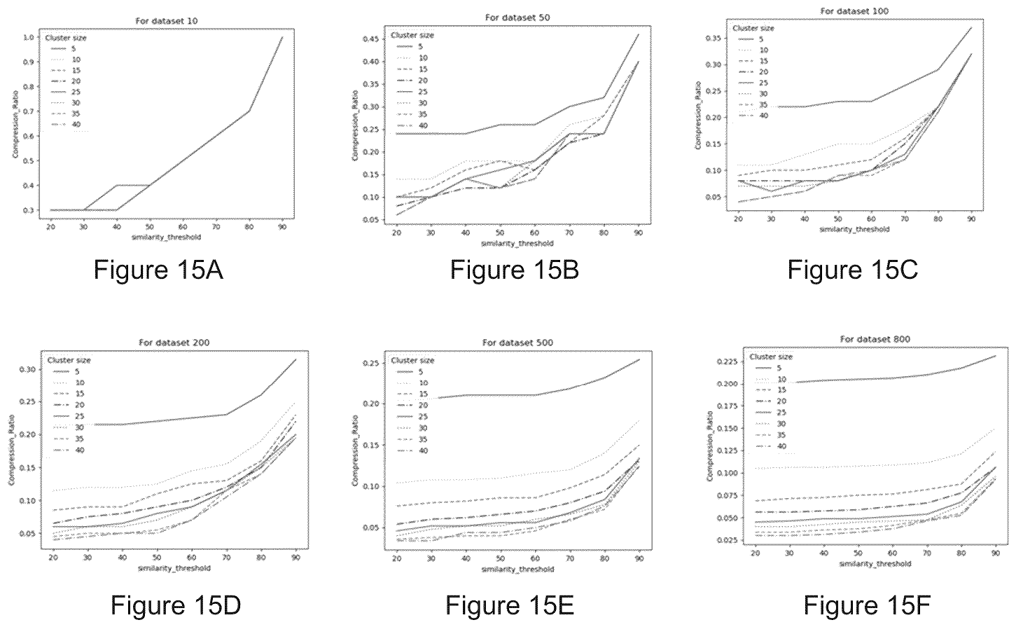

Further, FIGS. 14A-14E illustrate a few exemplary depictions of variation of the compression ratio with respect to similarity threshold and the cluster sizes during sampling of a set of data points associated with a single class, for various exemplary data sets of different sizes (e.g., 10, 100, 1000, 3000, 6000). Similarly, FIGS. 15A-15F illustrate yet another exemplary depiction of variation of the compression ratio with respect to similarity threshold and the cluster sizes during sampling of a set of data points associated with a single class, for various exemplary data sets of different sizes (e.g., 10, 50, 100, 200, 500, 800). As depicted, the sampling methodology as explained throughout the disclosure, develops stable characteristics with larger data sets.

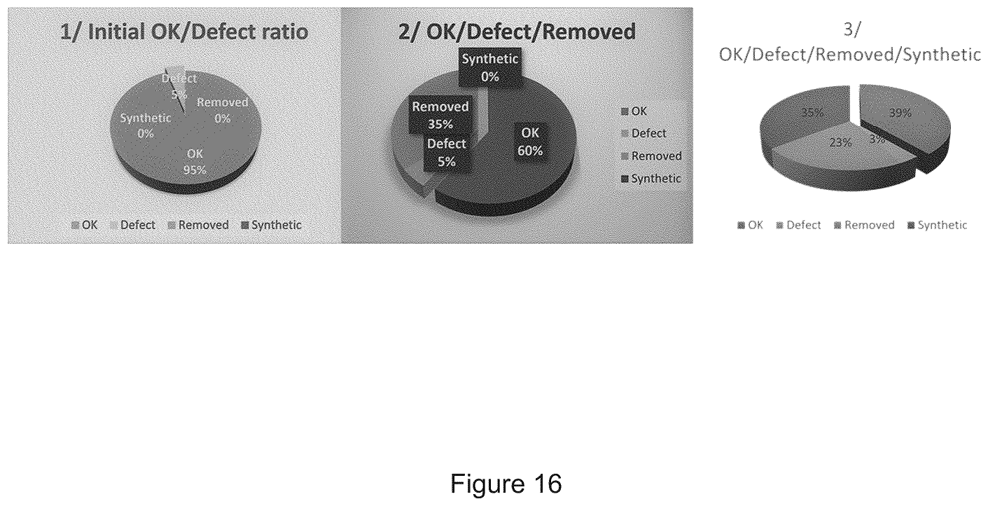

FIG. 16 illustrates an exemplary use case scenario depicting a series of pie charts indicating balancing in datasets using sampling and augmentation processes, according to various embodiments of the present invention.

Given an unbalanced data set as input (i.e., number of initial set of data points>number of defects), the first part of the invention (sampling/reduction) reduces the amount of redundant information from the majority class, as depicted in PIE CHART 1. In most cases, this is not enough to obtain a balanced dataset (Number of initial data set=Number of Defects), as depicted in PIE CHART 2. Further, the second part of the invention increases the number of defect images until the desired performance is obtained, i.e., PIE CHART 3.

The present invention provides for various technical advancements based on the key features discussed above. First, the present invention facilitates in down sampling a dataset by a factor of 80% and still achieve single digit false positive rate comparable to the false positive rate (FPR) of a model, based on a dataset manually annotated by an experienced engineer. The FPR indicates the proportion of true negatives that are misclassified as positives. Thus, the present invention facilitates in cutting down manual intervention and associated cost while still retaining the robustness of the model.

Additionally, the present sampling method does not require check(s) for misclassification, as the criteria for selection is the intrinsic statistical features of the dataset and not the characteristics of a model like some of the previously known models (e.g., related to Condensed Nearest Neighbour Rule Undersampling). Further, the present invention facilitates a dynamic selection of a number of examples to form a cluster based on the neighbour count and threshold selected (e.g., if neighbourhood count is 5, selection may be made in cluster of size 1, 2, 3, 4, or 5 and is not fixed to a rigid value, like some previously known models). This allows for a more relaxed selection criteria and ensures only redundant data is removed over known rigid value models such as near miss understanding. Additionally, the presented sampling method for majority class doesn't require any knowledge of the minority class nor the border between the two classes. The sampling is performed from data points in the overall distribution of datapoints and not just localized to a border, as known in some previously known methods.

Further, upon combining sampling and data augmentation, the present invention is able to outperform existing methods and reduce the problem caused by imbalanced dataset beyond conventional methods.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. A method for sampling a set of data points associated with a single class, the method comprising:
receiving a required number of reduced set of data points;
determining a neighbour count for the set of data points based on the required number of reduced set of data points and based on a number of the set of data points;
creating a plurality of clusters from the set of data points, each of the plurality of clusters comprising a plurality of similar data points selected based on a similarity threshold, wherein a number of the plurality of similar data points in each of the plurality of clusters is less than or equal to the neighbour count;
for each of the plurality of clusters, selecting a representative data point from the plurality of similar data points; and
providing the reduced set of data points based on representative data points, wherein a number of the representative data points corresponds to the received required number of reduced data points.

2. The method as claimed in claim 1 further comprising:
determining a compression ratio based on the number of the set of data points and the count of required number of reduced set of data points; and
determining the neighbour count and the similarity threshold based on the compression ratio.

3. The method as claimed in claim 1 further comprising:
determining whether the reduced set of data points is within a predefined range of the required number of reduced set of data points;
determining a modified set of data points after removing the plurality of similar data points from the set of data points;
determining whether the modified set of data points has a similarity greater than another similarity threshold in response to a determination that the reduced set of data points is not within the predefined range of the required number of reduced set of data points; and
repeating the steps of determining the neighbour count, creating, selecting, and providing in response to a determination that the modified set of data points has a similarity greater than the another similarity threshold.

4. The method as claimed in claim 1 further comprising:
determining whether the reduced set of data points is within a predefined range of the required number of reduced set of data points; and
providing the reduced set of data points based on the representative data points in response to a determination that the reduced set of data points is within the predefined range of the required number of reduced set of data points.

5. The method as claimed in claim 1 further comprising:
extracting at least one statistical feature for each data point of the set of data points;
determining a statistical distance between the at least one statistical feature of each of two data points from the set of data points, wherein the two data points are identified within a particular threshold distance; and
selecting the plurality of similar data points from the set of data points based on the determined statistical distance among the plurality of similar data points, wherein a count of the plurality of similar data points is less than or equal to the neighbour count.

6. The method as claimed in claim 1 comprising:
receiving information related to full distribution of data points in an unbalanced set of data points associated with a plurality of classes, wherein the set of data points are included within the unbalanced set of data points; and
automatically determining the required number of reduced set of data points based on the full distribution of data points in the unbalanced set of data points.

7. The method as claimed in claim 1, wherein selecting, for each of the plurality of clusters, the representative data point from the plurality of similar data points comprises one of:
selecting a seed data point, which is used to initiate formation of the corresponding cluster, as the representative data point;
selecting the seed data point, which is used to initiate formation of the corresponding cluster, and another closest data point within the corresponding cluster, as the representative data point;
selecting the seed data point, which is used to initiate formation of the corresponding cluster, and another farthest data point within the corresponding cluster, as the representative data point;
generating and selecting a mean data point of the plurality of similar data points within the corresponding cluster, as the representative data point; and
generating and selecting a median data point of the plurality of similar data points within the corresponding cluster, as the representative data point.

8. A system for sampling of a set of data points associated with a single class, the system comprising:
a memory storing instructions; and
a processor configured to execute the instructions to perform operations to:
receive a required number of reduced set of data points;
determine a neighbour count for the set of data points based on the required number of reduced set of data points and based on a number of the set of data points;
create a plurality of clusters from the set of data points, each of the plurality of clusters comprising a plurality of similar data points selected based on a similarity threshold, wherein a number of the plurality of similar data points in each of the plurality of clusters is less than or equal to the neighbour count;
for each of the plurality of clusters, select a representative data point from the plurality of similar data points; and
provide the reduced set of data points based on representative data points wherein a number of the representative data points corresponds to the received required number of reduced data points.

9. A method for sampling and augmenting a dataset of images associated with a first class and a second class, respectively, to balance the dataset of images, the method comprising:
receiving a required number of reduced set of images associated with the first class;
creating a plurality of clusters from a set of images associated with the first class based on the required number of reduced set of images;
for each of the plurality of clusters, selecting a representative image from a plurality of similar images in the corresponding cluster;
providing the reduced set of images based on representative images, wherein a number of the representative images corresponds to the received required number of reduced images;
generating a median image corresponding to the set of images associated with the first class, wherein the median image represents a background of the set of images;
creating a non-defect artifact mask based on a difference of intensity occurring at each pixel between the median image and the set of images associated with the first class;
extracting a defect foreground based on the median image and each defect image of another set of images associated with the second class, wherein the defect foreground comprises the defect and at least one non-defect artifact;
removing the at least one non-defect artifact from the defect foreground based on the non-defect artifact mask to generate a defect foreground without artifacts for each defect image; and
providing, for each defect image, a new synthetic defect image based on the median image and the defect foreground without artifacts.

10. The method as claimed in claim 9, wherein generating the median image comprises:
calculating, for each pixel of the median image, a median intensity occurring at the corresponding pixel across the set of images associated with the first class; and
generating the median image based on the calculated median intensity for each pixel of the set of images associated with the first class.

11. The method as claimed in claim 9 further comprising:
creating a library of each of the defect foreground without artifacts associated with each defect image;
sampling at least one defect foreground without artifacts from the library;
cropping and morphing the selected at least one defect foreground without artifacts to generate a morphed version of the at least one defect foreground without artifacts;
blending the morphed version of the at least one defect foreground without artifacts into a new foreground to generate a new defect foreground; and
providing the new synthetic defect image based on the median image and the new defect foreground.

12. The method as claimed in claim 9 further comprising:
determining whether the new synthetic defect image indicates performance improvement by performing an ablation test performance on the new synthetic defect image;
outputting the new synthetic defect image as a final output based on a determination that the new synthetic defect image indicates performance improvement; and
repeating the steps of generating the median image, creating, extracting defect foreground, removing, and providing the new synthetic defect image based on a determination that the new synthetic defect image does not indicate performance improvement.

13. The method as claimed in claim 9 further comprising:
determining whether the new synthetic defect image satisfies a performance target for a classifier by performing an ablation test performance on the new synthetic defect image;
outputting the new synthetic defect image as a final output based on a determination that the new synthetic defect image satisfies the performance target;
identifying one or more misclassified images in response to a determination that the new synthetic defect image does not indicate performance improvement; and
repeating the steps of generating the median image, creating, extracting defect foreground, removing, and providing the new synthetic defect image for the one or more misclassified images.

14. The method as claimed in claim 9, wherein at least one non-defect artifact comprises an edge within the image.

15. A system for sampling and augmenting a dataset of images associated with a first class and a second class, respectively, to balance the dataset of images, the system comprising:
a memory storing instructions; and
a processor configured to execute the instructions to perform operations to:
receive a required number of reduced set of images associated with the first class;
create a plurality of clusters from a set of images associated with the first class based on the required number of reduced set of images;
for each of the plurality of clusters, select a representative image from a plurality of similar images in the corresponding cluster;
provide the reduced set of images based on representative images, wherein a number of the representative images corresponds to the received required number of reduced images;
generate a median image corresponding to the set of images associated with the first class, wherein the median image represents a background of the set of images;
create a non-defect artifact mask based on a difference of intensity occurring for each pixel between the median image and the set of images associated with the first class;
extract defect foreground based on the median image and each defect image from another set of images associated with the second class, wherein the defect foreground comprises the defect and at least one non-defect artifact;
remove the at least one non-defect artifact from the defect foreground based on the non-defect artifact mask to generate a defect foreground without artifacts for each defect image; and
provide, for each defect image, a new synthetic defect image based on the median image and the defect foreground without artifacts.
